(19) United States
(12) Patent Application Publication
(10) Pub. No.: US 2004/0097663 A1
(43) Pub. Date: May 20, 2004

(54) Stabilising polymeric, organosilicon or silicone compositions

(76) Inventors: Thomas Deforth, Lyon (FR); Gerard Mignani, Lyon (FR); Christian Pusineri, Serezin Du Rhone (FR)

Correspondence Address: Jean-Louis Seugnet, Rhodia Inc, Intellectual Property Department, 259 Prospect Plains Road CN 7500, Cranbury, NJ, 08512-7500, US

(21) Appl. No.: 10/332,673

(22) PCT Filed: Jul. 12, 2001
(86) PCT No.: PCT/FR01/02270

(30) Foreign Application Priority Data
Jul. 13, 2000 (FR) 00/09237

(51) Int. Cl. C08G 77/00

(52) U.S. Cl. 525/474

(57) ABSTRACT

The invention relates to polyorganosiloxane polymers to which antioxidant functional groups have been grafted. These polymers can be used for the stabilization of polymer compositions, in particular non-organosilicon organic polymer compositions and silicone compositions. More particularly, they are used to stabilize silicone compositions intended for the preparation of moulds, in particular of moulds for the moulding of polyester items.

The present invention relates to novel additives with an antioxidant function which can be used in particular for the stabilization of polymer compositions, in particular polyaddition or polycondensation silicone compositions and non-organosilicon organic polymer compositions.

The invention also relates to organic polymer compositions and to silicone compositions comprising such additives.

A particular subject-matter of the invention is polyaddition and polycondensation silicone compositions and the elastomers resulting therefrom, e.g. constituent elastomers of moulds.

Another subject-matter of the invention is processes for the preparation of such compositions, elastomers and items, in particular silicone moulds, and the elastomers and items thus obtained. A more specific subject-matter of the invention is silicone elastomer moulds for the reproduction by moulding of decorative and industrial objects.

Organic polymer compositions, like silicone compositions, can comprise additives with an antioxidant function.

Furthermore, silicone compositions, in particular polycondensation silicone compositions, can be used for the reproduction by moulding of decorative and industrial objects. The reproduction of objects consists, in a first step, in manufacturing a negative of the object to be copied. This negative (membrane) is made in this instance of silicone elastomer. After crosslinking the silicone, the membrane is separated from the starting object. This membrane constitutes the mould which will be used for the reproduction of the object to be copied.

This type of mould is widely used for the reproduction of objects made of resin, such as polyester resin, which is capable of faithfully reproducing the finest details. However, during this use, the mould is subjected to gradual modifications: the constituents of the polyester resins, in particular styrene, diffuse into the membrane and are polymerized. The physicochemical structure of the mould in contact with the resins changes: it gradually hardens while losing its antiadhesive nature and its tear strength. These modifications finally result in surface fragments of the mould being torn off during removal from the mould. At this stage, the mould is no longer useable.

Various degradation mechanisms are involved. They can depend just as much on criteria related to the silicone elastomers as to the resins or to the moulding conditions. It is probable that the polymerization mechanism is a radical mechanism: formation of free radicals R• and ROO•, initiation and propagation of the radical polymerization of the styrene. High contents of styrene or of peroxide, the exothermic nature of the polymerization of the resin and the presence of oxygen are aggravating factors. The diversity of the factors which can influence the degradation of the silicone mould means that, until now, the solutions provided have never been entirely satisfactory.

One means of improving the resistance to polyester resins of a silicone mould consists in introducing, into the elastomer, antioxidant additives which tend to inhibit radical polymerization, such as inhibitors of free radicals, which deactivate the radicals R• and ROO• and prevent the initiation of radical polymerization.

European Patent Application EP-A-787 766 thus provides an improvement to the longevity of silicone moulds by incorporating, in the polycondensation composition, an antioxidant additive selected from a group composed of sterically hindered phenols, sterically hindered bisphenols, sterically hindered thiobisphenols, zinc dialkyldithiophosphates, zinc diaryldithiophosphates, aromatic amines or sterically hindered amines which can be 1-alkyl sebacates with a terminal NR group.

In FR-A-2 773 165, the additive is chosen from the group consisting of:

(a) additives comprising, in their structure, at least one R—S_{q}−R′ group in which R and R′ are monovalent hydrocarbonaceous groups having at least 3 carbon atoms or a monovalent hydrocarbonaceous group having an ester bond or R and R′ together form a ring, q being an integer of between 1 and 3 inclusive,

(b) additives which are inhibitors of free radicals and which are capable, under the moulding conditions, of generating at least one group:

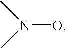

synergistic combination of (a)+(b), synergistic combination of (a) and/or (b) with phosphites (c).

The additives of type (a) of FR-A-2 773 165 include:

thiodicarboxylates of formula:

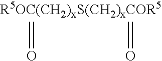

in which R⁵ is an alkyl group having from 1 to 15 carbon atoms inclusive and x is an integer of between 1 and 4 inclusive;

such as, for example, thiodipropionates, corresponding to the above formula where x=2, among which may be mentioned:

ditridecyl thiodipropionate (CAS 10595-72-9)

distearyl 3,3′-thiodipropionate (CAS 693-36-7)

dilauryl 3,3′-thiodipropionate (CAS 123-28-4);

compounds comprising several thioether groups R—S_{q}—R′ connected to a tetravalent carbon, preferably tetra(thioether)pentaerythritol, for example pentaerythritol tetra(laurylthiopropionate) or PETL (CAS 29 598-76-3).

EP-A-854 167 provides several types of additives, including sterically hindered phenols, thiodipropionic acids, polysulphides, phosphonates and the like.

Manufacturers try to introduce the greatest possible amount of these additives but come up against phenomena of exudation of the additive at the mould-moulded item interface, which leads to inhibition of the polymerization of the resin layer which is in contact with the surface of the mould. It would be advantageous to have available additives which can be incorporated, without risk of exudation, in a sufficient amount to provide a high degree of protection.

Similar problems of activity and of exudation are encountered in the field of the stabilization, in particular with respect to oxidation, of non-organosilicon organic polymers and in particular polyolefins and polyalkadienes.

Silicone polymers functionalized by grafting molecules from the group of the HALS (FR-A-2 635 780) or from the group of the benzotriazoles (FR-A-2 642 764) exist. The first are used, for their high refractive index, in coating compositions for optical fibres or as lubricant for plastics, such as PVC. The second are used for the photostabilization of organic polymers.

The Applicant has found that it is possible to use, as antioxidant for organic polymers and silicone compositions, polyorganosiloxane (POS) polymers carrying antioxidant functional groups obtained by the grafting to the POS of antioxidant additives, e.g. of the free radical inhibitor type.

According to a first form, such a POS polymer makes it possible to stabilize non-organosilicon organic polymers, in particular thermoplastics and thermoplastic or non-thermoplastic elastomers.

According to a second preferred form, such a POS polymer is capable of providing a stabilizing role with respect to oxidation for the silicone compositions incorporating it and for the elastomers thus produced, for example a stabilizing role for the silicone moulds obtained by this technology. Advantageously, such a POS polymer can optionally be a silicone constituent involved in the formation of the elastomeric network and thus one or more or all of the POS entities of the composition can be grafted with one or more of these additives.

A subject-matter of the present invention is thus the use, as antioxidant, in particular for polymer compositions, in particular for non-organosilicon organic polymers and/or for silicone compositions, of a POS polymer having essentially the structure of formula (1):

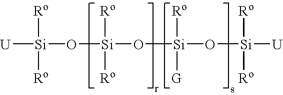

in which:

the R^{o} radicals, which are identical or different, are chosen from: the hydrogen atom, a hydrolysable group, a hydroxyl group and a monovalent hydrocarbonaceous group having in particular from 1 to 20 carbon atoms; mention may in particular be made, among monovalent hydrocarbonaceous groups, of alkyls, in particular C₁-C₁₀ alkyls, alkenyls, in particular C₂-C₁₀alkenyls, or aryls, in particular C₅-C₁₂ aryls; e.g.: methyl, ethyl, propyl, butyl, hexyl, octyl, vinyl, phenyl or 3,3,3-trifluoropropyl; preferably, at least 80% of the R^{o} radicals are methyl;

the U units, which are identical or different, are chosen from R^{o}, G, a hydrogen atom, a hydrolysable group, a hydroxyl group and an alkenyl group;

G is a residue resulting from an antioxidant additive, e.g. from a free radical inhibitor; by definition, G is known as the stabilizing functional group;

r is an integer chosen between 0 and 400;

s is an integer chosen between 0 and 100;

r+s is between 0 and 500, preferably between 10 and 100;

if s 0, at least one of the U radicals is G; or that of formula (2):

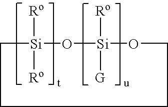

in which:

R^{o} and G have the same meanings as in the formula (1);

u is an integer between 1 and 20;

t is an integer between 0 and 20;

t+u>3, preferably between 3 and 10.

The term “having essentially the structure indicated” is understood to mean that it is also possible to have R^{o}G″ SiO_{2/2} units in the chain, where G″ is a functional group of the type of those which have been used to attach the precursor of the G functional group and which has not been involved in such an attachment. G″ can thus have various natures, for example H, OH, vinyl, thiol or carbinol. The number of these units can vary depending upon how the grafting reaction has been carried out. They generally number between 1 and 60% of the value of s.

The POS polymer is preferably linear (formula (1)) and, in this case, use is more preferably made of POS polymers where s≧1. In this case, the U radicals are preferably different from G. Also preferably, r=0 to 50 and s=0 to 50.

The grafting of antioxidant functional groups to POS entities generally makes it possible to obtain additives with an improved lifetime and/or reduced coefficient of diffusion with respect to the ungrafted additives from which these antioxidants result. This can also make it possible to improve the compatibility of the additive with the composition to which it is added. These properties have favourable consequences on the stability of the compositions targeted by the invention.

As was explained above, in a first form, a subject-matter of the invention is such a use for the stabilization of organic polymers (and of the products formed from these compositions), in particular polyolefines, polyalkadienes, polystyrenes, polyurethanes, polyamides, polyesters, polycarbonates, polysulphones, polyethersulphones, polyetherketones, acrylic polymers, their copolymers and their blends; it relates more particularly to polyolefins and polyalkadienes, such as polypropylene, high density polyethylene, linear low density polyethylene, low density polethylene, polybutadiene, their copolymers and their blends. The invention is targeted in particular at the stabilization of organic polymers against thermooxidative degradation.

In the context of this form, it is preferable for the POS entities to be devoid of reactive U or R^{o} groups, that is to say in particular of hydrolysable groups or of H, hydroxyl or alkenyl groups.

According to the second form, which is preferred, a subject-matter of the invention is such a use for the stabilization with respect to oxidation of silicone compositions and elastomers. More particularly, the invention relates to the stabilization of the constituent silicone compositions and elastomers of moulds, such as those intended for the moulding of polyester items, in order in particular to prevent, within the silicone elastomer, radical polymerization, e.g. of the styrene resulting from the polyester resin, without interfering with the polymerization at the core and at the surface of the moulded item, e.g. of the polyester.

In comparison with conventional additives, the aim in the silicone moulds application is in particular to obtain a reduced coefficient of diffusion of the POS additive and/or the weakening, indeed even the elimination, of the phenomena of inhibition at the mould-moulded item interface and/or an increase in the longevity of the moulds.

A subject-matter of the invention is thus the use of these POS entities for weakening or inhibiting the phenomena of inhibition at the mould-moulded item interface and/or for increasing the longevity of the moulds. In a particularly preferred way, the use is targeted at obtaining an increased number of mouldings per mould with respect to the use of conventional additives, e.g. increased by more than 30%, 50%, indeed even 100%.

In accordance with the invention, the POS polymers carrying stabilizing residues can themselves be constituents of the silicone composition intended to form the elastomeric network. To do this, the POS polymer then carries reactive U and/or R^{o} groups, that is to say hydrolysable groups, or hydroxyl or alkenyl groups, for example SiOH, SiH or SiVi units. Apart from this case, it is preferable for the POS entities to be devoid of such groups.

The POS polymers according to the invention can furthermore develop a plasticizing effect which participates in the maintenance of the integrity of the items, in particular of the silicone items, e.g. of the moulds.

In the field of silicones, the presence of Si—O—Si linkages can also make it possible to increase the compatibility of these POS entities by developing interactions with the reinforcing fillers possibly present in the composition.

Various grafting methods will appear to a person skilled in the art according to the type of silicone oil and the antioxidant functional group to be grafted. Mention may be made, as examples of advantageous grafting methods, of the methods involving the following reactions:

A) Hydrosilylation, represented, for example, by the reaction scheme below:

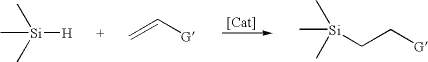

The stabilizing functional group is represented diagrammatically using the symbol G′, with G=G′+grafting structure (for example, in this case

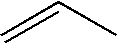

The catalyst is a conventional catalyst for the type of reaction under consideration. In this instance, platinum-based compounds may be mentioned as hydrosilylation catalyst.

B) Dehydrogenation/condensation, represented, for example, by the reaction scheme below:

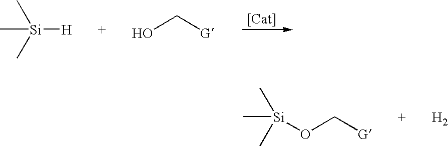

Catalyst: idem A)

C) Condensation, represented, for example, by the reaction scheme below:

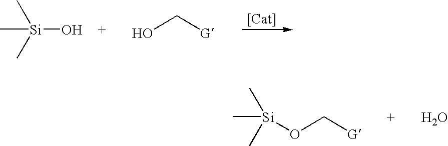

Catalyst (Cat)=conventional catalyst, e.g. metal carboxylate or metal chelate

D) Transesterification, represented, for example, by the reaction scheme below:

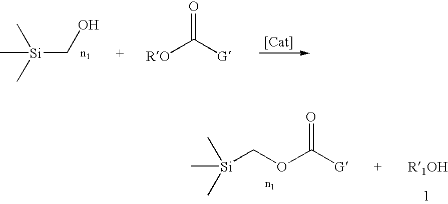

n₁, =1 to 10

R₁′=alkyl or aryl

Conventional catalyst, e.g. metal alkoxide

E) Nucleophilic substitution of a halogen functional group, represented, for example, by the reaction scheme below

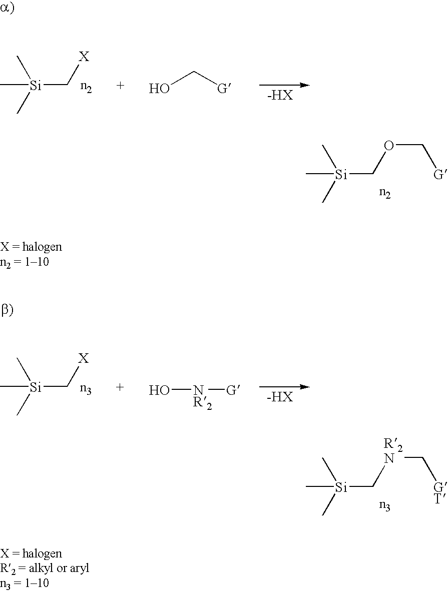

F) Addition to an epoxy functional group, represented, for example, by the reaction scheme below

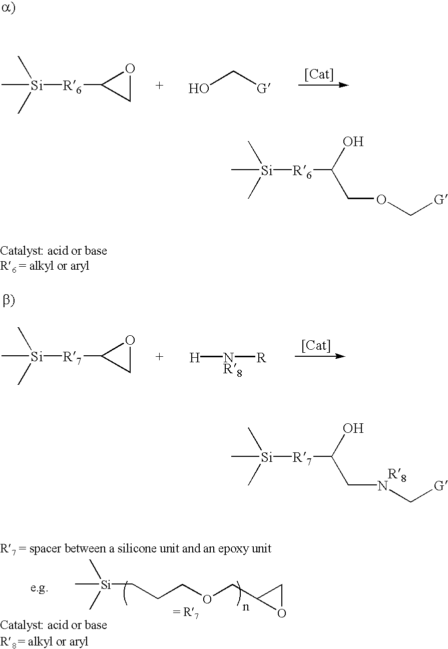

In the formula (1) or (2), G can result from any additive generally used as antioxidant, for example, in accordance with the preferred form of the invention, any free radical inhibitor, for example such as those disclosed in EP-A-787 766 and FR-A-2 773 165. G can in particular result from the following compounds:

(i) sterically hindered mono- and polyphenols or sterically hindered thio(mono- and poly)phenols, such as, in particular, those disclosed in EP-A-787 766 and EP-A-854 167, carrying, or to which has been added, an unsaturated, alcohol or ester functional group (when the compound in question does not naturally comprise the functional group which allows it to be grafted to the POS, an appropriate functional group is added to the compound by methods known to a person skilled in the art). Mention may be made, by way of examples, of: 2,6-di(t-butyl)phenol, 2,6-di(t-butyl)-4-methylphenol, octadecyl 3,5-di(t-butyl)4-hydroxyhydrocinnamate, 4,4′-methylenebis(2,6-di(t-butyl)phenol), 4,4′-methylenebis(2,6dimethylphenol), 2,2′-methylenebis(4-methyl-6-(t-butyl)phenol), 2,2′-ethylidenebis(4,6-di(t-butyl)phenol), 2,2′-methylenebis(4-methyl-6-(1-methylcyclohexyl)phenol), 4,4′-butylidenebis(6-t-butyl-3-methylphenol), 1,1′-thiobis(2-naphthol), 2,2′-thiobis(4-methyl-6-t-butylphenol), 2,2′-isobutylidenebis (4,6-dimethylphenol), monomethacrylate ester of 2,2′-methylenebis(4-ethyl-6t-butylphenol), 1,3,5-trimethyl-2,4,6-tris(3,5di(t-butyl)-4-hydroxybenzyl)benzene, 4,4′-thiobis(6-t-butyl-3-methylphenol), 4,4′-thiobis(4,6-di(t-butyl)phenol), 2,6-di(t-butyl)-p-cresol, 2-t-butyl-4-methoxyphenol, 3-t-butyl-4-methoxyphenol, alkyl-, dialkyl- or trialkyl-substituted phenols with C₁ to C₃₀ alkyl, styrylphenol, distyrylphenol, tristyrylphenol, tetrakis(methylene 3-(3,5-di(t-butyl)-4-hydroxyphenyl)propionate)methane, 1,3,5-trimethyl-2,4,6-tris(3,5-di(t-butyl)-4-hydroxybenzyl)benzene, 1,3,5-tris(3,5-di(t-butyl)-4-hydroxybenzyl)-s-triazine-2,4,6(1H,3H,5H)-trione, 2,4-bis(n-octylthio)-6-(4-hydroxy-3,5-di(t-butyl)amino)-1,3,5-triazine, 4-(hydroxy-methyl)-2,6-di(t-butyl)phenol or 2,2-diphenyl-1-picrylhydrazyl.

(2i) aromatic amines, such as in particular those disclosed in EP-A-787 766, carrying or to which is added an unsaturated, phenol ether or NH functional group. Mention may be made, by way of examples, of: N-phenylbenzylamine, N-phenyl-1-naphthylamine, 4,4′-di (α,α′-dimethylbenzyl)-diphenylamine, 4,4′-di(2,4,4-trimethylpentyl)-diphenylamine, N,N′-diphenyl-1,4-phenylenediamine, N-phenyl-N′-(1,3-dimethylbutyl)-1,4-phenylenediamine or 4-anilinophenyl methacrylate.

(3i) hindered amines referred to as HALS of N—OR, N—R and N—H type (Hindered Amine Light Stabilizers —see Oxidation Inhibition in Organic Materials, Vol. II, Chapter 1: Hindered amines as photostabilizers, Jiri Sedlar), carrying or to which is added an unsaturated, alcohol or ester functional group. Reference may also be made to EP-A-432 096, EP-A-787 766 and FR-A-773 165. Typical commercial amines are sold under the name Tinuvin® by Ciba-Geigy, Novartis or Sankyo. Mention may in particular be made of those composed of a or comprising at least one group:

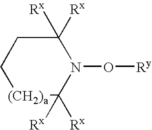

in which R^{y} is hydrogen or a linear or branched C₁ to C₁₈ alkyl, optionally substituted by one or more phenyl groups, or a C₅ to C₆ cycloalkyl or benzyl, a is 0 or 1, preferably 1, and the Rx radicals, which are identical to or different from one another, are chosen from linear or branched C₁ to C₃ alkyl, phenyl and benzyl radicals.

(4i) amine N-oxides carrying or to which is added an unsaturated functional group.

(5i) phosphines and phosphites, in particular alkyl phosphites, mixed aryl alkyl phosphites, aryl phosphites and various phosphites, carrying or to which is added an ester or halogen functional group, e.g.:

triphenyl phosphite, triisodecyl phosphite, trilauryl phosphite, dilauryl phosphite, diphenyl isodecyl phosphite, diphenyl isooctyl phosphite, diphenyl 2-ethylhexyl phosphite, diisodecyl phenyl phosphite, trimonononylphenyl phosphite, 2,4-dinonylphenyl di(4-monononylphenyl) phosphite, tris(2,4-di(tert-butyl)phenyl) phosphite (CAS 31570-04-4), 2,2-methylenebis(4,6-di(t-butyl)phenyl) octyl phosphite, a product sold under the name Sandostab® P-EPQ by Sandoz AG, Basle, Switzerland, [CH₃(CH₂)₁₁S]₃P or 2,2′-ethylidenebis(4,6-di(t-butyl)phenyl) fluorophosphite CAS 118337-09-0.

(6i) antioxidant additives which, once grafted to the POS, comprise at least one group of formula

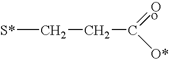

These additives are attached to the POS either via the S* or via the O*. They can be obtained, for example, by:

transesterification from

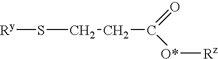

in which Z^{z} is H or preferably a linear or branched alkyl radical having from 1 to 15 carbon atoms and R^{y} is a linear or branched alkyl radical having from 1 to 40 carbon atoms; attaching is carried out via the O*.

by addition of Michael type:

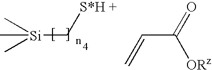

n₄=1 to 10

Other methods are described below.

Mention may thus be made of the following compounds: tridecyl thiodipropionate, distearyl 3,3′-thiodipropionate, di(tridecyl thiodipropionate) or dilauryl 3,3′-thiodipropionate.

According to a specific form, a subject-matter of the invention is such a use for non-organosilicon organic polymers in which G is defined as above, the piperidyl functional groups described (which correspond to HALSs) in FR-A-2 642 764 being excluded.

By way of examples:

| | | | Commercial | |
|---|---|---|---|---|
| | | | name or | Grafting |
| | | CAS No. | supplier | method |
| | Hindered phenols | | | |
| | carrying an: | | | |
| 1) | Unsaturated | | | |
| | functional group: | | | |
| a) | 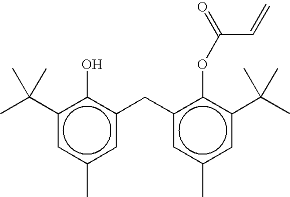 | [61167-58-6] | IRGANOX 3052 (CIBA) or Sumilizer GM (Sumimoto) | A |
| b) | 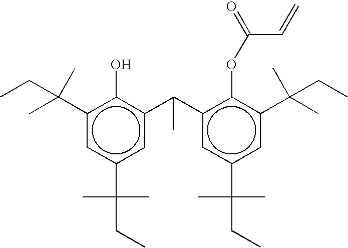 | [128961-68-2] | Sumilizer GS (Sumitomo) | A |
| c) | 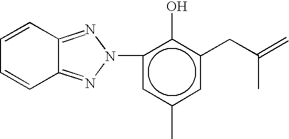 | | (CIBA) | A |
| 2) | Alcohol | | | |
| | functional group: | | | |
| a) | 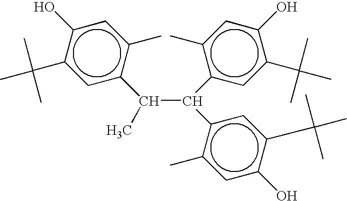 | [1843-03-04] | Topanol CA (ICI) | B, C, E (α) H (α) |
| b) | 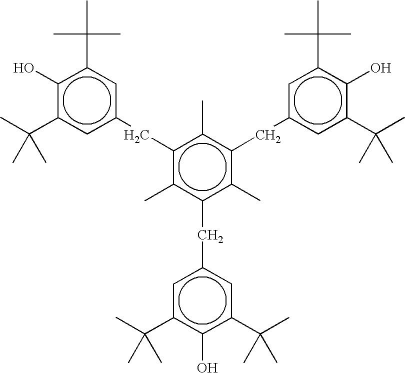 | [1709-70-2] | Irganox 1330 (CIBA) | B, C, E (α) H (α) |
| 3) | Ester functional | | | |
| | group: | | | |
| a) | 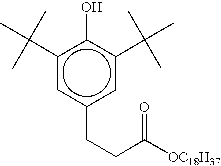 | [2082-79-3] | Irganox 1076 (CIBA) Anox PP18 (Great Lakes) | D |
| b) | 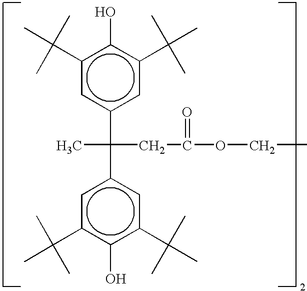 | [32509-66-3] | Hostanox 03 (Hoechst) | D |
| | Aromatic amines | | | |
| | carrying an: | | | |
| 1) | Unsaturated | | | |
| | functional group: | | | |
| a) | 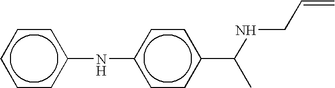 | — | | A |
| b) | 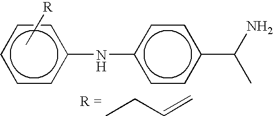 | — | A | |
| 2) | Phenolic ether | | | |
| | functional group: | | | |
| a) | 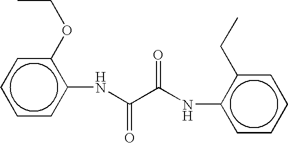 | [23949-66-8] | Tinuvin 312 (CIBA) Sanduvor (Clariant) | Similar to D |
| 3) | NH functional | | | |
| | group: | | | |
| a) | 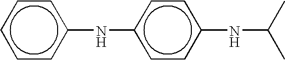 | [101-72-4] | Vulcanox 4010 NA (Bayer) | E (β) , F (β) |
| b) | 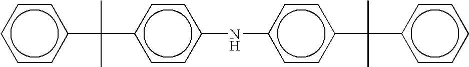 | [10081-67-1] | Naugard 445 (Uniroyal) | E (β) , F (β) |
| | Hindered amines | | | |
| | carrying an: | | | |
| 1) | Unsaturated | | | |
| | functional group: | | | |
| a) | 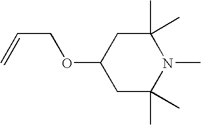 | | | |
| 2) | Alcohol | | | |
| | functional group: | | | |
| a) | 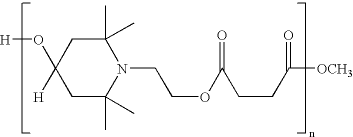 | [70198-29-7] | Tinuvin 622LD (CIBA) | B, C, E (α) F (α) |
| 3) | Ester | | | |
| | functional group: | | | |
| a) | 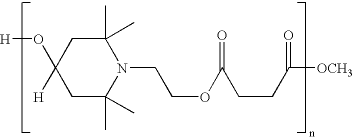 | [70198-29-7] | Tinuvin 622LD (CIBA) | D |
| | Amine N-oxides | | | |
| | carrying an: | | | |
| 1) | Unsaturated | | | |
| | functional group: | | | |
| a) | 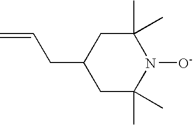 | — | | A |
| | Phosphines or phosphites | | | |
| | carrying an: | | | |
| 1) | Ester | | | |
| | functional group: | | | |
| a) | 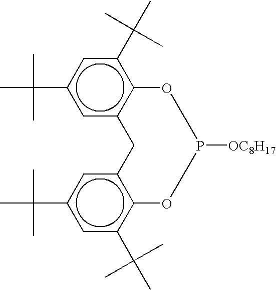 | — | Mark AO HP-10 (Palmarole Sarl) | S |
| b) | 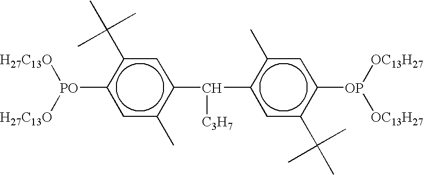 | — | Mark AO-P123 (Palmarole Sarl) | S |
| 2) | Halogen | | | |
| | functional group: | | | |
| a) | 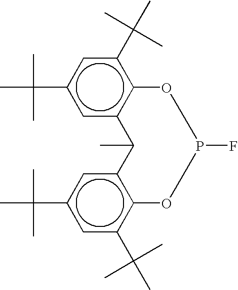 | [118337-09-0] | Ethanox 398 | Reaction with the SiOH, Si(CH₂)ₙOH and Si(CH₂)ₙNHR′and epoxy units possible |
| | Thiopropionates | | | |
| | carrying an: | | | |
| 1) | Unsaturated. | | | |
| | functional group: | | | |
| a) | 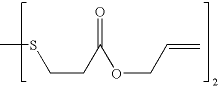 | [39557-51-2] | | A |
| 2) | OH functional group: | | | |
| a) | 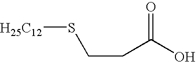 | [1462-52-8] | | B, C, E (β) F (α) |
| 3) | Ester | | | |
| | functional group: | | | |
| a) | 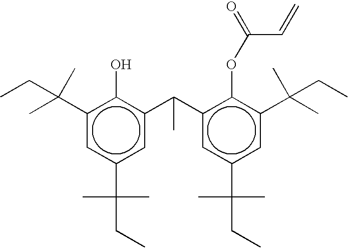 | [1975975-2] | Additif PE03 (Rhodia Silicone) | D |

A POS polymer according to the invention can carry one or more G stabilizing functional groups and it preferably carries several of them which may be identical or different.

Another subject-matter of the invention is, of course, the grafted POS polymers as disclosed in the present application.

A particular subject-matter of the invention is the POS polymers thus grafted, with the exception of those carrying piperidyl and benzotriazole functional groups according to FR-A-2 642 764 and FR-A-2 635 780 respectively.

Another subject-matter of the invention is the processes for the preparation of these POS polymers from functionalized or nonfunctionalized silicone oils, in particular processes A) to H).

According to the first form, another subject-matter of the invention is stabilized organic polymer compositions comprising POS polymers according to the invention, with the exception of those carrying piperidyl functional groups according to FR-A-2 642 764. Mention may be made, by way of examples of organic polymers, of polyolefins, polyalkadienes, polystyrenes, polyurethanes, polyamides, polyesters, polycarbonates, polysulphones, polyethersulphones, polyetherketones, acrylic polymers, their copolymers and their blends; they are more particularly polyolefins and polyalkadienes, such as polypropylene, high density polyethylene, linear low density polyethylene, low density polyethylene, polybutadiene, their copolymers and their blends.

These organic polymer compositions comprise an effective amount of POS according to the invention, in particular from 0.1 to 15% and preferably from 0.5 to 2%, with respect to the stabilized composition. Other characteristics and distinctive features of the PoSs to be employed have been given above.

Another subject-matter of the invention is a process for the preparation of these organic polymer compositions stabilized by the incorporation of a sufficient amount of POS in accordance with the invention, with the exception of those carrying piperidinyl functional groups according to FR-A-2 642 764.

According to the preferred form of the invention, the invention relates to silicone compositions comprising at least one POS polymer in accordance with the invention, to the elastomers obtained by crosslinking these compositions and to the products formed, e.g. the moulds.

According to a specific embodiment, one of the usual constituents of the silicone composition, in particular a polyorganosiloxane, that is to say a constituent of the elastomeric network, constitutes the POS polymer according to the invention, that is to say that it carries one or more G functional groups in accordance with the invention. Of course, it is possible to have various combinations, for example it is possible to have a POS polymer which does not participate in the definition of the constituents of the elastomeric network and one or more constituents of this network which carry G functional groups.

As will be seen later, in the case where the silicone composition is a polyaddition composition, it is preferable not to use G functional groups comprising radicals, such as SH or NH2, which may be poisonous to the catalyst used to crosslink these compositions.

These silicone compositions comprise an effective amount of POS according to the invention, in particular from 0.1 to 15%, preferably from 0.5 to 2%, with respect to the stabilized composition. Other characteristics and distinctive features of the POSs to be employed have been given above.

Another subject-matter of the invention is a process for the preparation of silicone compositions or of silicone elastomers capable in particular of being used for the preparation of moulds, in which at least one grafted silicone oil or polymer according to the invention is added to a conventional elastomer-precursor silicone composition.

All the characteristics given below apply to the various subject-matters of the invention (use, grafted POS polymer, compositions, products or preparation processes).

The invention can be applied to silicone compositions which can be crosslinked at room temperature (it being possible for the crosslinking to be accelerated under warm conditions) by polyaddition or polycondensation reaction.

The present invention applies in particular to the silicone compositions which are a precursor of a silicone elastomer comprising:

(A) a diorganopolysiloxane oil exhibiting reactive groups chosen from i) condensable, hydrolysable or hydroxyl terminal groups and 2i) alkenyl groups, preferably vinyl groups, bonded to silicon;

(B) optionally a compound chosen from the group consisting of silanes comprising condensable or hydrolysable groups, in the case where (A) is chosen from the groups i), and of diorganopoly-siloxane oil carrying hydrogen atoms, in the case where (A) is chosen from the groups 2i);

(C) a catalyst;

(D) optionally any other additive conventionally used in the type of composition under consideration;

(E) a POS of formula (1) or (2); and/or the oil (A) and/or the compound (B) carry G functional groups.

A first group of silicones which can be used according to the invention therefore comprises diorganopolysiloxane compositions which can be cured to a silicone elastomer by polycondensation reactions comprising:

(A) at least one diorganopolysiloxane oil carrying, at each end of the chain, at least two condensable or hydrolysable groups or a single hydroxyl group,

(B) a silane comprising at least three condensable or hydrolysable groups and/or a product originating from the partial hydrolysis of this silane, when (A) is an oil with hydroxyl ends,

(C) a catalyst for the polycondensation of the oil,

(E) a POS of formula (1) or (2); and/or the oil (A) and/or the compound (B) carry G functional groups.

In that which follows or that which precedes, unless otherwise mentioned, the percentages are by weight.

The diorganopolysiloxane oils (A) which can be used in the compositions according to the invention are more particularly those corresponding to the formula (3):

YₙSiR₃₋ₙO(SiR₂O)ₓSiR₃₋ₙYₙ

in which:

R represents identical or different monovalent hydrocarbonaceous radicals, Y represents identical or different hydrolysable or condensable groups (other than OH) or hydroxyl groups, and optionally at least one of the R groups is a G functional group,

n is chosen from 1, 2 and 3, with n=1 when Y is a hydroxyl, and x is an integer greater than 1, preferably greater than 10.

The viscosity of the oils of formula (3) is in particular between 50 and 10⁶ mPa·s at 25° C.

Mention may be made, as examples of R radicals, of alkyl radicals having from 1 to 8 carbon atoms, such as methyl, ethyl, n-propyl, butyl, hexyl and octyl, vinyl radicals or phenyl radicals.

Mention may be made, as examples of substituted R radicals, of 3,3,3-trifluoropropyl, chlorophenyl and β-cyanoethyl radicals.

In the products of formula (3) generally used industrially, at least 60%, preferably at least 80%, by number of the R radicals are methyl radicals, the other radicals generally being phenyl and/or vinyl radicals (in particular at most 1%).

Mention may be made as examples of hydrolysable Y groups, of the amino, acylamino, aminoxy, ketiminoxy, iminoxy, enoxy, alkoxy, alkoxyalkyleneoxy, acyloxy and phosphato groups and, for example, among these:

for amino Y groups: n-butylamino, sec-butylamino and cyclohexylamino groups,

for N-substituted acylamino groups: the benzoylamino group,

for aminoxy groups: the dimethylaminoxy, diethylaminoxy, dioctylaminoxy and diphenylaminoxy groups,

for iminoxy and ketiminoxy groups: those derived from acetophenone oxime, acetone oxime, benzophenone oxime, methyl ethyl ketoxime, diisopropyl ketoxime and chlorocyclohexanone oxime,

for alkoxy Y groups: the groups having from 1 to 8 carbon atoms, such as the methoxy, propoxy, isopropoxy, butoxy, hexyloxy and octyloxy groups,

for alkoxyalkyleneoxy Y groups: the methoxyethyleneoxy group,

for acyloxy Y groups: the groups having from 1 to 8 carbon atoms, such as the formyloxy, acetoxy, propionyloxy and 2-ethylhexanoyloxy groups,

for phosphate Y groups: those deriving from the dimethyl phosphate, diethyl phosphate and dibutyl phosphate groups.

Mention may be made, as condensable Y groups, of hydrogen atoms and halogen atoms, preferably chlorine.

The oils (A) are preferably α, ω-dihydroxylated diorganopolysiloxanes of formula (3); then Y=OH, n=1 and x is such that the viscosity is in particular between 500 and 500 000 mPa·s at 25° C., preferably between 800 and 400 000 mPa·s at 25° C.

These linear polymers are composed essentially of diorganosiloxyl units of formula (R₂SiO) However, the presence of other units, generally present as impurities, such as RSiO_{3/2}, RSiO_{1/2} and SiO_{4/2}, is not excluded in the proportion in particular of at most 1% with respect to the number of diorganosiloxyl units.

Mention may be made, as illustration of units represented by the formula R₂SiO, of those of formulae: (CH₃)₂SiO; CH₃(CH₂═CH)SiO; CH₃(C₆H₅)SiO; CF₃CH₂CH₂(CH₃)SiO; NC—CH₂CH₂(CH₃)SiO; NC—CH₂(C₆H₅)SiO.

The great majority of these base oils are commerically available from silicone manufacturers. Furthermore, their manufacturing techniques are well known; they are found disclosed, for example, in French Patents FR-A-1 134 005, FR-A-1 198 749, FR-A-1 226 745.

When, in the formula (3), the Y groups are hydroxyl groups, n is then equal to 1 and it is necessary, in order to prepare polyorganosiloxane elastomers from these polymers of formula (3), to use, in addition to the condensation catalysts, crosslinking agents (B) which are silanes of general formula:

R₄₋ₐSiY′a (4)

in which:

R has the meanings given above in the formula (3) (and at least one of the R groups of which can optionally be a G functional group), Y′ represents identical or different hydrolysable or condensable groups and a is equal to 3 or 4.

The examples given for the Y groups are applicable to the Y′ groups.

It is desirable to use silanes of formula (4) even in the case where, in the oil (A), Y does not comprise hydroxyl groups. In this case, it is desirable to use Y groups of the oil (A) which are identical to the Y′ groups of the silane (B).

Mention may more particularly be made, as examples of silanes (B) of formula (4), of polyacyloxysilanes, polyalkoxysilanes, polyketiminoxysilanes and polyiminoxysilanes and in particular the following silanes:

CH₃Si(OCOCH₃)₃; C₂H₅Si(OCOCH₃)₃; (CH₂═CH)Si(OCOCH₃)₃;

C₆H₅Si(OCOCH₃)3; CF₃CH₂CH₂Si(OCOCH₃)₃; NC—CH₂CH₂Si(OCOCH₃)₃;

CH₂ClSi(OCOCH₂CH₃)₃; CH₃Si(ON═C(CH₃)C₂H₅)₂OCH₂CH₂OCH₃;

CH₃Si (ON═CH—CH₃)₂OCH₂CH₂OCH₃.

The above silanes (B), in combination with α, ω-dihydroxylated polydiorganosiloxanes of formula (3), can be used in single-item compositions which are stable with the exclusion of air.

Mention may be made, as examples of monomeric silanes of formula (4) which, in combination with α, ω-dihydroxylated polydiorganosiloxanes of formula (3), can advantageously be used in two-item compositions, of polyalkoxysilanes and in particular those of formulae:

Si(OCH₂H₅)₄; Si(O-n-C₃H₇)₄; Si (O-isoC₃H₇)₄;

Si (OC₂H₄OCH₃)₄; CH₃Si (OCH₃)₃; CH₂═CHSi (OCH₃)₃;

CH₃Si (OC₂H₄OCH₃)₃; ClCH₂Si (OC₂H₅)₃;

CH₂═CHSi (OC₂H₄OCH₃)₃.

The monomeric silanes described hereinabove can be substituted, in all or in part, by polyalkoxypolysiloxanes, each molecule of which numbers at least two, preferably three, Y′ atoms; the other valencies of the silicon are satisfied by SiO and SiR siloxane bonds.

Mention may be made, as an example of a polymeric crosslinking agent, of poly(ethyl silicate).

Use is generally made of 0.1 to 20 parts by weight of crosslinking agent of formula (4) per 100 parts by weight of polymer of formula (3).

The crosslinking agents (B) of formula (4), whether they can be used for the preparation of single-item or two-item compositions, are products accessible on the silicones market; furthermore, their use in compositions which cure from room temperature is known; it figures in particular in French Patents FR-A-1 126 411, FR-A-1 179 969, FR-A-1 189 216, FR-A-1 198 749, FR-A-1 248 826, FR-A-1 314 649, FR-A-1 423 477, FR-A-1 432 799 and FR-A-2 067 636.

The polyorganosiloxane compositions which can be cured to an elastomer of the type which is described hereinabove can comprise in particular from 0.001 to 10 parts by weight, preferably from 0.05 to 3 parts by weight, of condensation catalyst (C) per 100 parts by weight of polysiloxane of formula (3).

The content of condensation catalyst in the single-item compositions is generally much lower than that used in the two-item compositions and can in particular be between 0.001 and 0.05 part by weight per 100 parts by weight of polysiloxane of formula (3).

These catalysts will be described in more detail later.

The compositions according to the invention can additionally comprise reinforcing or semi-reinforcing or bulking fillers which are preferably chosen from siliceous fillers.

The reinforcing fillers are preferably chosen from fumed silicas and precipitated silicas. They have in particular a specific surface area, measured according to the BET method, of at least 50 m²/g, preferably of greater than 70 m²/g, a mean size of the primary particles preferably of less than 0.1 μm (micrometre) and a bulk density preferably of less than 200 g/litre.

These silicas can be incorporated without modification or after having been treated with organosilicon compounds commonly used- for this use. During these treatments, the silicas can increase their starting weight up to a level of 20%, preferably 18%, approximately. Siloxanes and cyclosiloxanes, e.g. methylpolysiloxanes, such as hexamethyldisiloxane, octamethyldisiloxane or octamethylcyclotetrasiloxane, silazanes, e.g. methylpolysilazanes, such as hexamethyldisilazane or hexamethylcyclotrisilazane, chlorosilanes, such as dimethylchlorosilane, trimethylchlorosilane, methylvinyldichlorosilane or dimethylvinylchlorosilane, and alkoxysilanes, such as dimethyldimethoxysilane, dimethylvinylethoxysilane or trimethylmethoxysilane, appear among the treatment compounds.

The filler can also be treated in situ, in particular with one of the above agents and more particularly with silazanes, such as hexamethyldisilazane (hmdz). In this case, the treatment agent can be incorporated in the silicone composition before the silica, after it or on both occasions.

The term “in situ treatment of the siliceous filler” is understood to mean that the filler and the compatibilizing agent are brought together in the presence of at least a portion of polyorganosiloxane silicone oil (A). In a particularly preferred way, this consists essentially in introducing compatibilizing agent (CA) on two occasions in the preparation medium:

on the one hand, before and/or substantially simultaneously with bringing together at least a portion of the silicone oil employed and at least a portion of the siliceous filler used, this introduction of CA (portion 1) being carried out one or more times and corresponding to a portion of less than or equal to 8%, preferably of less than or equal to 5% and more preferably still of less than or equal to 3% by dry weight with respect to the total filler;

and, on the other hand (portion 2), after this operation in which silicone oil and filler are brought together.

The compatibilizing agent of portion 1 is thus chosen from molecules which satisfy at least two criteria:

exhibits a strong interaction with the silica at its hydrogen bonds with itself and with the surrounding silicone oil,

is itself, or its decomposition products, easily discharged from the final mixture by heating under vacuum or under a gas stream and compounds of low molecular weight are thus preferred.

The term “overall equivalent amount” is understood to mean observing the order of magnitude of the molar amounts of the CA with respect to the hydrogen bonds.

The agent of portion 1 can be, for example:

a silazane, preferably a disilazane, or their mixtures, hexamethyldisilazane (hmdz) being the preferred silazane, which can be used in combination with divinyltetramethyldisilazane,

a di- or preferably monofunctional hydroxylated siloxane,

an amine, such as ammonia or an alkylamine of low molecular weight, such as diethylamine,

an organic acid of low molecular weight, such as formic acid or acetic acid,

and is preferably employed in the presence of water.

The compatibilizing agents of portion 2 can be chosen from the various silazanes and disilazanes encountered hereinabove, taken alone or as mixtures with one another, preferably from disilazanes, hexamethyldisilazane, in combination or not in combination with divinyltetramethyldisilazane, being particularly preferred.

For further details, the person skilled in the art can refer to WO-A-98 58997 or to French Patent Application 98 16510, filed on Dec. 23, 1998.

Use may also be made of an untreated silica, jointly with the use of additives which facilitate the processing (processing aids), for example hydroxylated or methoxylated silicone fluids or alternatively functional silanes.

The semi-reinforcing or bulking fillers have a particle diameter preferably of greater than 0.1 μm (micrometre) and are chosen in particular from ground quartz, calcined clays and diatomaceous earths.

Use may generally be made of 0 to 100 parts, preferably of 5 to 80 parts, of filler per 100 parts of oil (A).

The bases for silicone compositions defined in a general way hereinabove are well known to a person skilled in the art. They are described in detail in the literature and the majority are commercially available. These compositions crosslink at room temperature in the presence of atmospheric moisture and/or moisture present in the composition. They are divided into two main families. The first family is composed of single-item compositions or compositions comprising a single package which are stable on storage with the exclusion of atmospheric moisture and which cure to an elastomer with atmospheric moisture. In this case, the condensation catalyst (C) used is a metal compound, generally a tin, titanium or zirconium compound.

Depending on the nature of the condensable or hydrolysable groups, these single-item compositions are said to be acidic, neutral or basic.

Mention may be made, as acidic compositions, of, for example, the compositions disclosed in Patents U.S. Pat. Nos. 3,035,016, 3,077,465, 3,133,891, 3,409,573, 3,438,930, 3,647,917 and 3,886,118.

Use may be made, as neutral compositions, of, for example, the compositions disclosed in Patents U.S. Pat. Nos. 3,065,194, 3,542,901, 3,689,454, 3,779,986, GB-A-2 052 540, U.S. Pat. No. 4,417,042 and EP-A-69 256.

Use may be made, as basic compositions, of, for example, the compositions disclosed in Patents U.S. Pat. Nos. 3,378,520, 3,364,160, 3,417,047, 3,742,004 and 3,758,441.

Use may also be made, according to a preferred alternative form, of single-item flowing compositions, such as those disclosed in Patents U.S. Pat. Nos. 3,922,246, 3,956,280 and 4,143,088.

The second family, which is the preferred family in the context of the present invention, is composed of two-item compositions or compositions comprising two packages which preferably comprise an α, ω-dihydroxydiorganopolysiloxane oil (A), a silane (B) or a product originating from partial hydrolysis of this silane, a catalyst (C) which is a metal compound, preferably a tin compound, and/or an amine, and a POS of formula (1) or (2); and/or the oil (A) and/or the compound (B) carry G functional groups.

Examples of such compositions are disclosed in Patents U.S. Pat. Nos. 3,678,002, 3,888,815, 3,933,729, 4,064,096 and GB-A-2 032 936.

The two-item compositions comprising:

(A) 100 parts of an α, ω-dihydroxydiorganopolysiloxane oil with a viscosity of 50 to 300 000 mPa·s, the organic radicals of which are chosen from methyl, ethyl, vinyl, phenyl and 3,3,3-trifluoropropyl radicals, at least 60%, preferably 80%, by number being methyl radicals, it being possible for up to 20% by number to be phenyl radicals and it being possible for at most 2% to be vinyl radicals,

(B) from 0.5 to 15 parts of a polyalkoxysilane or polyalkoxysiloxane,

(C) from 0.01 to 1 part (calculated as weight of tin metal) of a catalytic tin compound,

(D) from 0 to 100 parts, preferably from 5 to 80 parts, of siliceous inorganic filler,

(E) a POS of formula (1) or (2); and/or the oil (A) and/or the compound (B) carry G functional groups,

are well suited.

The two-item silicone compositions having the following composition, expressed as parts by weight:

from 25 to 75 parts of a hydroxyl-terminated polydimethylsiloxane (PDMS) characterized by a viscosity of 5 to 100 Pa·s,

from 10 to 50 parts of a PDMS comprising trimethylsilyl endings which is characterized by a viscosity of 20 to 2 000 mPa·s,

from 15 to 30 parts of a siliceous inorganic filler, in particular silica, characterized by an expanded specific surface area of at least 90 m²/g,

from 3 to 10 parts of compatibilizing agent, e.g. hmdz,

from 1 to 5 parts of water,

from 0 to 40 parts of a ground silica filler with a mean particle size of approximately 5 to 10 μm,

an effective amount (see above) of a POS of formula (1) or (2); and/or one or both PDMSs carry G functional groups,

are also well suited.

Such a composition can be crosslinked under cold conditions by addition of a catalysing mixture comprising at least one crosslinking molecule, such as an at least trifunctional alkoxysilane (e.g. methyl silicate, ethyl silicate or methyltrimethoxysilane), and a catalyst for the polycondensation of silicones, such as a tin catalyst.

The tin catalysts are extensively described in the above literature; this can be in particular a tin salt of a mono- or dicarboxylic acid. These tin carboxylates are described in particular in the work by Noll (Chemistry and Technology of Silicones, page 337, Academic Press, 1968, 2^{nd} edition). Mention may in particular be made of the naphthenate, the octanoate, the oleate, the butyrate, dibutyltin dilaurate, dibutyltin diacetate or demethyltin didecanoate. Use may also be made, as catalytic tin compound, of the reaction product of a tin salt, in particular of a tin dicarboxylate, with poly(ethyl silicate) as disclosed in Patent U.S. Pat. No. 3,186,963. Use may also be made of the reaction product of a dialkyldialkoxysilane with a tin carboxylate, as disclosed in Patent U.S. Pat. No. 3,862,919. Use may also be made of the reaction product of an alkyl silicate or of an alkyltrialkoxysilane with dibutyltin diacetate, as disclosed in Belgian Patent BE-A-842 305. Use may also be made of the phenyltrimethoxysilane/dimethyltin didecanoate pair.

Preference is more particularly given, among the crosslinking agents (B), to alkyltrialkoxysilanes, alkyl silicates and poly(alkyl silicate)s in which the organic radicals are alkyl radicals having from 1 to 4 carbon atoms.

The alkyl silicates can be chosen from methyl silicate, ethyl silicate, isopropyl silicate, n-propyl silicate and the polysilicates chosen from the products from the partial hydrolysis of these silicates; these are polymers composed of a high proportion of units of formula (R⁴O)₃SiO_{0.5}, R⁴SiO_{1.5}, (R⁴O)₂SiO and SiO₂, the R⁴ symbol representing the methyl, ethyl, isopropyl or n-propyl radicals. Their characterization is usually based on their silica content, which is established by quantitative determination of the product from the hydrolysis of a sample.

Use may in particular be made, as polysilicate, of a partially hydrolysed ethyl silicate sold under the trade name “Ethyl Silicate-40®” by Union Carbide Corporation or a partially hydrolysed propyl silicate.

The polycondensation compositions can additionally comprise from 10 to 130 parts by weight of polydimethylsiloxane oil(s) blocked at each of the chain ends by a (CH₃)₃SiO_{0.5} unit, with a viscosity at 25° C. of between 10 and 5 000 mPa·s, per 100 parts of oil(s) (A).

In addition, the compositions can optionally comprise adjuvants for the crosslinking, such as hydroxylated fluids, for example water, and silicones, pigments and/or specific adjuvants.

The compositions according to the invention can be shaped, extruded and in particular moulded over a shape from which it is desired to take the impression and can then be cured at room temperature to an elastomer with atmospheric moisture or with addition of water. Gentle heating at a temperature of 20 to 150° C. can accelerate the curing.

A second group of silicones which can be used according to the invention are polyaddition compositions which can be cured to an elastomer by hydrosilylation reactions, characterized in that they comprise:

(A) at least one diorganopolysiloxane oil exhibiting, per molecule, at least two alkenyl groups, preferably vinyl groups, bonded to silicon,

(B) at least one diorganopolysiloxane oil exhibiting, per molecule, at least three hydrogen atoms bonded to silicon,

(C) a catalytically effective amount of a catalyst which is generally a compound of a metal from the platinum group,

(D) optionally any other additive conventionally used in this type of composition, e.g. a filler,

(E) a POS of formula (1) or (2); and/or the oil (A) and/or the oil (B) carry G functional groups, preferably avoiding G functional groups comprising groups of the SH or NH₂ type, thus the functional groups of type (2i).

The amounts of (A) and (B) are generally chosen so that the molar ratio of the hydrogen atoms bonded to silicon in (B) to the vinyl radicals bonded to silicon in (A) is generally between 0.4 and 10, preferably between 0.6 and 5.

The vinyl groups in (A) and the hydrogen atoms in (B) are generally bonded to different silicon atoms.

These compositions crosslink by an addition reaction (also known as a hydrosilylation reaction), catalysed by a compound of a metal from the platinum group, of a vinyl group of the organopolysiloxane (A) with a hydride functional group of the organopolysiloxane (B).

The vinylated organopolysiloxane (A) can be an organopolysiloxane exhibiting siloxyl units of formula (5):

$${Y}_{a} {Z}_{b} {SiO}_{\frac{( 4 - a - b )}{2}}$$

in which Y is a vinyl group, Z is a monovalent hydrocarbonaceous group not having an unfavourable effect on the activity of the catalyst, Z generally being chosen from alkyl groups having from 1 to 8 carbon atoms inclusive, such as the methyl, ethyl, propyl and 3,3,3-trifluoropropyl groups, and aryl groups, such as xylyl, tolyl and phenyl, a is 1 or 2, b is 0, 1 or 2 and a+b is between 1 and 3, all the other units optionally being units of mean formula (6):

$${Z}_{c} {SiO}_{\frac{4 - c}{2}}$$

in which Z has the same meaning as hereinabove and c has a value of between 0 and 3;

optionally at least some of the Y and/or Z radicals being able to be G functional groups, preferably with the exclusion mentioned above.

The organopolysiloxane (B) can be an organohydropolysiloxane comprising siloxyl units of formula (7):

$${H}_{d} {W}_{e} {SiO}_{\frac{4 - d - e}{2}}$$

in which W is a monovalent hydrocarbonaceous group not having an unfavourable effect on the activity of the catalyst which corresponds to the same definition as Z, d is 1 or 2, e is 0, 1 or 2, and d+e has a value of between 1 and 3, all the other units optionally being nits of mean formula (8):

$${W}_{g} {SiO}_{\frac{4 - g}{2}}$$

in which W has the same meaning as hereinabove and g has a value of between 0 and 3;

optionally at least some of the W radicals being able to be G functional groups, preferably with the exclusion mentioned above.

The organopolysiloxane (A) can be formed solely of units of formula (5) or can additionally comprise units of formula (6).

The organopolysiloxane (A) can exhibit a linear, branched, cyclic or network structure. The degree of polymerization is 2 or more and is generally less than 5 000. Furthermore, if the organopolysiloxane (A) is linear, it exhibits in particular a viscosity at 25° C. of less than 500 000 mPa·s.

Z is generally chosen from the methyl, ethyl and phenyl radicals, 60 mol % at least of the Z radicals being methyl radicals.

The organopolysiloxanes (A) and (B) are well known and are disclosed, for example, in Patents U.S. Pat. Nos. 3,220,972, 3,284,406, 3,436,366, 3,697,473 and 4,340,709.

Examples of siloxyl units of formula (5) are the vinyldimethylsiloxyl unit, the vinylphenylmethylsiloxyl unit, the vinylsiloxyl unit and the vinylmethylsiloxyl unit.

Examples of siloxyl units of formula (6) are the SiO_{4/2}, dimethylsiloxane, methylphenylsiloxane, diphenylsiloxane, methylsiloxane and phenylsiloxane units.

Examples of organopolysiloxane (A) are dimethylpolysiloxanes comprising dimethylvinylsiloxyl ends, methylvinyldimethylpolysiloxane copolymers comprising trimethylsiloxyl ends, methylvinyldimethylpolysiloxane copolymers comprising dimethylvinylsiloxyl ends and cyclic methylvinylpolysiloxanes.

The organopolysiloxane (B) can be formed solely of units of formula (7) or additionally comprises units of formula (8).

The organopolysiloxane (B) can exhibit a linear, branched, cyclic or network structure. The degree of polymerization is 2 or more and is generally less than 5 000.

The W group has the same meaning as the above Z group.

Examples of units of formula (7) are:

H(CH₃)₂SiO_{1/2}, HCH₃SiO_{2/2} or H(C₆H₅)SiO_{2/2}.

The examples of units of formula (8) are the same as those given above for the units of formula (6).

Examples of organopolysiloxane (B) are dimethylpolysiloxanes comprising hydrodimethylsilyl ends, dimethylhydromethylpolysiloxane copolymers comprising trimethylsiloxyl ends, dimethylhydromethylpolysiloxane copolymers comprising hydrodimethylsiloxyl ends, hydromethylpolysiloxanes comprising trimethylsiloxyl ends and cyclic methylvinylpolysiloxanes.

The ratio of the number of hydrogen atoms bonded to silicon in the organopolysiloxane (B) to the number of groups comprising alkenyl unsaturation of the organopolysiloxane (A) is in particular between 0.4 and 10, preferably between 0.6 and 5.

The organopolysiloxane (A) and/or the organopolysiloxane comprising (B) units can be diluted in a nontoxic organic solvent compatible with silicones.

The network organopolysiloxanes (A) and (B) are commonly known as silicone resins.

The bases for the silicone polyaddition compositions may comprise only linear organopolysiloxanes (A) and (B), such as, for example, those disclosed in the abovementioned United States patents: U.S. Pat. Nos. 3,220,972, 3,697,473 and 4,340,709, or may, at the same time, comprise branched or network organopolysiloxanes (A) and (B), such as, for example, those disclosed in the abovementioned United States patents: U.S. Pat. Nos. 3,284,406 and 3,436,366.

The polyaddition composition can additionally comprise polydimethylsiloxane oil or oils (in particular from 5 to 40 parts by weight) blocked at each of the chain ends by a (CH₃)₃SiO_{0.5} unit; and optionally being able to comprise G functional groups, preferably with the exclusion mentioned above. Their viscosity at 25° C. is in particular between 10 and 5 000 mPa·s, per 100 parts of the organopolysiloxanes (A)+(B).

The catalysts (C) are also well known. Platinum and rhodium compounds are preferably used. Use may be made of the complexes of platinum and of an organic product disclosed in U.S. Pat. Nos. 3,159,601, 3,159,602 and 3,220,972 and European Patents EP-A-57 459, EP-A-188 978 and EP-A-190 530 and the complexes of platinum and of vinylated organopolysiloxane disclosed in the United U.S. Pat. Nos. 3,419,593, 3,715,334, 3,377,432 and 3,814,730. Use may be made of the rhodium complexes disclosed in the United Kingdom patents: GB-A-1 421 136 and GB-A-1 419 769.

Platinum catalysts are preferred. In this case, the amount by weight of catalyst (C), calculated as weight of platinum metal, is generally between 2 and 600 ppm, in general between 5 and 200 ppm, based on the total weight of the organopolysiloxanes (A) and (B).

The preferred polyaddition compositions in the context of the present invention are those which comprise:

(A): 100 parts of a diorganopolysiloxane oil blocked at each end of its chain by a vinyldiorganosiloxyl unit, the organic radicals, bonded to the silicon atoms, of which are chosen from the methyl, ethyl and phenyl radicals, at least 60 mol % of these radicals being methyl radicals, with a viscosity of 100 to 500 000, preferably of 1 000 to 200 000, mPa·s at 25° C.;

(B): at least one organohydropolysiloxane chosen from liquid linear or network homopolymers and copolymers exhibiting, per molecule, at least 3 hydrogen atoms bonded to different silicon atoms, the organic radicals, bonded to the silicon atoms, of which are chosen from the methyl, ethyl and phenyl radicals, at least 60% of these radicals being methyl radicals, the product (B) being used in an amount such that the molar ratio of hydride functional groups to the vinyl groups is between 1.1 and 4;

(C): a catalytically effective amount of a platinum catalyst;

(E): a POS of formula (1) or (2); and/or the oil (A) and/or the oil (B) carry G functional groups, preferably with the exclusion mentioned above.

The compositions according to the invention can additionally comprise reinforcing or semi-reinforcing or bulking fillers (D) as described hereinabove in the context of the polycondensation compositions.

Use may generally be made of 5 to 100 parts, preferably of 5 to 50 parts, of filler per 100 parts of the sum of the organopolysiloxanes (A)+(B).

The polyaddition compositions are generally stored in two packages. This is because they crosslink as soon as all their constituents are mixed. If it is desired to delay this crosslinking in order to obtain good homogenization of the active material, an inhibitor of the platinum catalyst can be added to the composition.

These inhibitors are well known. Use may in particular be made of organic amines, silazanes, organic oximes, dicarboxylic acid diesters, acetylenic alcohols, acetylenic ketones or vinylmethylcyclopolysiloxanes (see, for example, U.S. Pat. Nos. 3,445,420 and 3,989,667). The inhibitor is used in a proportion of 0.005 to 5 parts, preferably of 0.01 to 3 parts, per 100 parts of the constituent (A).

In order to obtain good homogenization in the distribution of the active material, it is in fact desirable for the silicone matrix to exhibit a degree of viscosity in particular of the order of 5 000 to 30 000 mPa·s at 25° C. Such a viscosity can be obtained by a precrosslinking, the latter being blocked at the desired viscosity by addition of an inhibitor. Sufficient time is thus available to thoroughly homogenize the active material within the silicone matrix. The crosslinking is then brought to completion by heating the matrix at a temperature such that the inhibitor no longer has an effect on the catalytic action of the platinum.

The compositions according to the invention can be cold kneaded as they are and can be shaped, in particular moulded over the shape to be reproduced.

The invention does not exclude either the combination of the POSs and compositions according to the invention with ungrafted additives, in particular those described above as compounds capable of being grafted.

In the case where an ungrafted additive is used in addition, it is possible in particular to use the compound bis(1-octyloxy-2,2,6,6-tetramethyl-4-piperidyl) sebacate and thiodipropionates and monothiopropionates, such as described above, in particular methyl laurylthiopropionate MeLTP: C₁₂H₂₅—S—CH₂—CH₂—CO—O—CH₃.

A further subject-matter of the invention is the silicone elastomer moulds capable of being obtained by crosslinking a polyaddition or polycondensation composition as described above. Another subject-matter of the invention is the silicone elastomer obtained.

The present invention will now be described in more detail with the help of embodiments taken as nonlimiting examples.

### EXAMPLE 1

### Preparation of a POS Carrying Laurylthiopropionate Functional Groups (POS)

The POS is obtained by transesterification of methyl laurylthiopropionate with an oil M-D₉-D₄-M according to the reaction scheme:

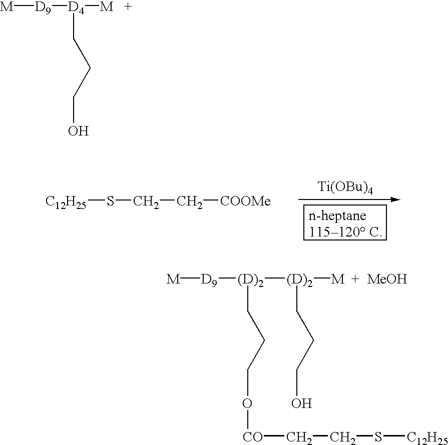

Comment:

M unit: monofunctional (CH₃)₃SiO_{1/2} unit

D unit: difunctional (CH₃)₂SiO_{2/2} unit

Description of the test:

The oil, the methyl laurylthiopropionate and

the butyl titanate are weighed out in a 500 ml three-necked flask equipped with a mechanical stirrer; 150 ml of n-heptane are subsequently added. The round-bottomed flask is heated at 120° C. The equilibrium is shifted towards the formation of the new esterified oil by distillation of the methanol, which forms an azeotrope with the solvent. Heating is maintained until complete distillation of the expected amount of methanol. The mixture is subsequently devolatilized.

Characteristics of the POS:

The proton and silicon-29 NMR analysis is in accordance with the structure given above.

Appearance: liquid at ambient temperature

Content of antioxidant sites: approximately 50% by number; approximately 50% by number of free OH groups remain

Refractive index: 1.444 at 25° C.

### EXAMPLE 2

### Preparation of a POS Carrying Functional Groups of Hindered Phenol Type (POS2)

25.1 g (64 mmol) of Irganox 3052 (sold by Ciba), 100 g of toluene, 0.22 g of a catalyst based on platinum on charcoal (2.5% by weight of Pt metal) and 25 mg of a solution comprising platinum (10% by weight) as catalyst in the homogeneous form are charged to a reactor equipped with a stirrer, a cooling column and a dropping funnel. The mixture is then heated with stirring and a nitrogen head space to 80° C. and 29.2 g (63 mmol SiH) of a polydimethylsiloxane silicone oil blocked at each of the ends of the chains by a (CH₃)₂HSiO_{0.5} unit (2.17 mmol SiH/g of oil) are run in over 20 minutes. After the oil has finished being run in, the temperature and the stirring are maintained for one day in order to bring the reaction to completion. After cooling and filtering through a board and membrane (0.45 μm) filter, the product is devolatilized (6.65×10² Pa/70° C./2 h).

48.1 g of an oil which is α, ω-functionalized with Irganox 3052 are obtained. Characteristics of the POS:

The proton and silicon-29 NMR analysis is in accordance with the structure with 27 mol% of grafting by hydrosilylation (SiH+C=C) and 53 mol % of grafting by dehydrogenation/condensation between the SiH units and the (aromatic) carbon-OH units.

Appearance: Liquid at ambient temperature.

### EXAMPLE 3

### Preparation of Another POS Carrying Functional Groups of Hindered Phenol Type (POS3)

34.6 g (88 mmol) of Irganox 3052 (sold by Ciba), 100 g of toluene and 0.22 g of a catalyst based on platinum on charcoal (2.5% by weight of Pt metal) are charged to a reactor equipped with a stirrer, a cooling column and a dropping funnel. The mixture is then heated with stirring and a nitrogen head space to 80° C. and 20 g (83 mmol SiH) of a poly(dimethyl)-(methylhydro)siloxane silicone oil comprising trimethylsilyl ends (4.1 mmol SiH/g of oil) are run in over 10 minutes. After reacting for 3 hours, 74 mg of a solution comprising platinum (10% by weight) as catalyst in the homogeneous form are added. After the solution has finished being run in, the temperature and the stirring are maintained for two days to bring the reaction to completion. After cooling and filtering through a board and membrane (0.45 μm) filter, the product is devolatilized (6.65×10² Pa/70° C./2 h) 45.4 g of a silicone oil which is functionalized in the middle of the chain with Irganox 3052 are obtained.

### EXAMPLE 4

### Preparation of Another POS Carrying Functional Groups of Aromatic Amine Type (POS4)

100 g (170 mmol as epoxy) of a polydimethylsiloxane silicone oil which is α, ω-functionalized with an ethylene glycidyl ether having 1.7 mmol epoxy/g of oil, 32 g (174 mmol) of N-phenyl-1,4-phenylenediamine (sold by Aldrich) and 10 ml of n-octane are charged to a reactor equipped with a stirrer and a cooling column and then this mixture is heated with stirring for 3 hours at 165° C.

After devolatilization (60° C./2.7×10² Pa/2 h), 126.65 g of a very viscous oil comprising N-phenyl-1,4-phenylenediamine grafted to the epoxy functional groups of the silicone oil are obtained.

### EXAMPLES 5 to 7

### Preparation of Silicone Compositions which Crosslink at Ambient Temperature by a Polycondensation Reaction

1) Base mixture: Rhodorsil® RTV V-2015, sold by Rhodia Silicones, St-Fons, France; with 0.5% of Tinuvin 123 (Ciba-Geigy)=bis(1-octyloxy-2,2,6,6tetramethyl-4-piperidyl) sebacate; the desired amount of additive is added thereto.

2) Catalysed mixture:

The catalyst Rhodorsil® Catalyst Hi Pro Green (HPG), sold by Rhodia Silicones, is added to the base mixture.

3) Processing of the RTV silicone:

The catalysed base mixture is homogenized and degassed. The product, thus degassed, is subsequently cast in the appropriate moulds. The overmoulded product (which will constitute a mould) is crosslinked at ambient temperature (23° C.) and is removed from the mould after 4 days. The characteristics of the elastomer are then as follows:

TABLE 1

| | Tear | Tensile | Elongation |
|---|---|---|---|
| Hardness | strength | strength | at break |
| - Sh A - | - kN/m - | - Mpa - | - % - |
| 17 | 18 | 3.6 | 450 |

4) Additives:

The impact of the POSs described in the preceding examples on the resistance to polyesters was compared with that which can be developed by conventional antioxidants with lower molecular weights. In the examples selected, the activity of the antioxidants chosen is based on the presence of thiopropionate and hindered phenol groups.

TABLE 2

| References | Chemical structure |
|---|---|
| PETL (Palmarole S.A.) | C[CH₂—O—OC—CH₂—CH₂—S— |
| | C₁₂H₂₅]₄ |
| DTDTDP | S[CH₂—CH₂—COOC₁₃H₂₇]₂ |
| | Ditridecyl thiodipropionate |
| Ex. 5: POS1 of Example 1 | POS oil comprising |
| | thiopropionate functional |
| | groups |
| Ex. 6: POS2 of Example 2 | POS oil comprising hindered |
| | phenol functional groups |
| Ex. 7: POS2 of Example 2 | POS oil comprising hindered |
| | phenol functional groups |

The following antioxidants, DTDTDP and organofunctional POS, are liquid at ambient temperature while PETL is a solid with a melting point in the region of 40-45° C.

TABLE 3
Characteristics of the additives:

| | | | | Solubility |
|---|---|---|---|---|
| | Melting | Boiling | | in the |
| | point | point | Molecular | silicone |
| References | ° C. | ° C. | mass | oil |
| PETL | ˜44 | — | ˜1 162 | <0.1% |
| POS, Example 1 | — | — | ˜1 600 | 1 to 2% |
| DTDTDP | — | 265 | ˜542 | 2.5 to 3% |

5) Polyester resin:

This entire study was carried out with a polyester resin comprising 40% of styrene sold under the name Synolite® 0328-A-1 and distributed by DSM, France. This resin is catalysed by the addition of 2% of Promox 200 (45% solution of methyl ethyl ketone peroxide in a mixture of organic solvents: phthalates and diacetone alcohol) and of 0.2% of accelerator (6% solution of cobalt octoate in white spirit). The gel time of this polyester resin is 25 min, the moulded item is removed from the mould in approximately 30 min and the crosslinking is completed in approximately 75 min.

6) Methods:

6-1: Introduction of the additives into the RTVs: these additives are introduced in the liquid form by direct dispersion in the base of the RTV using a propeller stirrer or manually. In the case of PETL, this product is melted at 50° C before being dispersed in the RTV.

6-2: Evaluation of the resistances to resins: the resistance to resins was evaluated using moulding tests which consist in carrying out, in a small mould of the RTV to be tested, successive castings and removals from the mould every 30 min of the polyester resin described in 6-1 until part of the mould is torn off at the time of removal from the mould.

A first type of mould used in these tests is a mould comprising spikes. This mould is cubic in shape (3.7×3.7×3.7 cm; thickness of the walls: 1.5 cm). 10 spikes with a height of 1 cm and a diameter of 0.2 cm are evenly distributed over the bottom of the mould. It is the tearing off of the spikes positioned at the bottom of these moulds which allows the resistance to resins to be characterized.

A second type of mould is a “figurine mould”: it represents a part of the face of a statue; it is obtained according to the technique of moulding under a case. In the context of this experimental model, the tearing always takes place at the same place in a brittle region which is situated in the hair of the figurine: the geometry of this brittle region corresponds in fact to a 1×2 cm strip with a thickness of 1 mm.

6-3 Other evaluation methods:

Brookfield viscosity

Shore A (Sh A) hardness: ASTM Standard D 2240

Tensile strength and elongation at break: ASTM Standard D 412

Tear test: ASTM Standard D 624, test specimen B

7) Results:

Three types of results are presented hereinbelow:

Mechanical properties of the RTV doped with the various antioxidants (containing 0.5 parts of Tinuvin and xx parts of one of the antioxidants which have just been described) and crosslinked with the HPG catalyst, except in the case of DTDTDP; in this case, the RTV is crosslinked with a catalyst, denoted by the name HPR, comprising: 27.80% of phenyltrimethoxysilane, 2.20% of tin salt (dimethyltin dineodecanoate), 33.24% of Mediaplast BSP solvent (mixture of 85% of (C₁₀-C₁₆)alkylbenzene and of 15% of organic solvent comprising ester functional groups, sold by Kettlitz), 11.76% of BC 589-BSP (colouring base: Mediaplast BSP 90.15 parts, Silica A-130 9 parts, Chromophthal Red BRN 0.85 parts) and 25.00% of DTDTDP;

Resistance to Synolite® 328 with the mould comprising spikes;

Resistance to Synolite® 328 with the figurine mould.

7-1 Mechanical properties:

TABLE 4
Impact of the additives on the
mechanical properties

| | | | | | |
|---|---|---|---|---|---|
| | | | Tear | Tensile | Elongation |
| Anti- | | Hardness | strength | strength | at break |
| oxidant | Content | -Sh A- | -kN/m- | -MPa- | -%- |

| | | | | | |
|---|---|---|---|---|---|
| Controls* | — | 17 | 18 | 3.6 | 450 |
| DTDTDP | 2.5% | 15 | — | — | — |
| PETL | 1.5% | 15 | 14 | 2.8 | 420 |
| POSl of | 2.5% | 14 | 18 | 2.6 | 450 |
| Example 1 | | | | | |

*Ungrafted Example 1 oil + catalyst Rhodorsil ® Catalyst Hi Pro Green.

From these results, the PETL leads to a significant deterioration in the tear strength of the elastomer. This development very probably results from the fact that the PETL recrystallizes after having been dispersed in the molten state in the RTV; the crystals have the form of needles.

The POS develops a visible plasticizing effect through the fall in the hardness without significantly affecting the tear strength.

7-2 Resistance to polyesters-moulds comprising spikes:

The resistances which appear in Table 5 below are characterized by the number of castings/removals from the mould which had to be carried out before the first spike was torn off. This table also gives, for each case, the concentration of antioxidant groups present in the moulds.

TABLE 5
Moulds comprising spikes-resistance
to polyesters (the first spike is torn off):

| | | Catalyst | Number of |
|---|---|---|---|
| Antioxidant | Content | 10 parts | items obtained |
| Controls | 0% | HPG | 44*, 52**, |
| | | | 50***, 42**** |
| PETL | 1.5% | HPG | 72* |
| DTDTDP | 2.5% | HPR | 62*, 62** |
| POS1 of Example 1 | 2.5% | HPG | 59*, 61** |
| POS1 of Ex. 1 | 5.0% | HPG | 64** |
| POS2 of Ex. 2 | 3.0% | HPG | 47**** |

*first series of tests
**second series of tests
***third series of tests
****fourth series of tests

Overall, the POS has a behaviour similar to that of the other additives with low molecular weights. In the context of these tests, it is the PETL which gives the best results but the possibilities of recrystallization of this additive in RTV networks has a negative impact on the mechanical properties of the moulds.

7-3 Resistance to polyesters—figurine mould:

The results obtained appear in Table 6 below.

TABLE 6

| | | Catalyst | Number of |
|---|---|---|---|
| Antioxidant | Content | 10 parts | items obtained |
| Controls | 0% | HPG | 74*, 70** |
| PETL | 1.5% | HPG | 91* |
| DTDTDP | 2.5% | HPR | 95* |
| POS1 of Ex. 1 | 1.5% | HPG | 80* |
| POS2 of Ex. 2 | 3.0% | HPG | 84** |
| POS3 of Ex. 3 | 3.0% | HPG | 87** |

### EXAMPLE 8

Examples 5 to 7 can be repeated using the following composition:

1) Base mixture:

Part A

1. 420 parts of a hydroxy-terminated PDMS characterized by a viscosity of 18 mPa·s,

2. 20 parts of water,

10 3. 44 parts of hmdz (hexamethyldisilazane),

4. 190 parts of a reinforcing silica characterized by an expanded specific surface area of 160 m²/g,

5. 112 parts of a PDMS comprising trimethylsilyl endings with a viscosity of 50 mPa·s,

6. 12 parts of a hydroxy-terminated PDMS characterized by a viscosity of 70 mPa·s

7. 4 parts of water.

These ingredients are added in the abovementioned order to a laboratory arm mixer with a capacity of 1.5 litres by applying the following process:

homogenization for approximately 15 min after introduction of components 1 to 3,

gradual incorporation of component 4 over approximately 1 hour,

additional homogenization for 30 min,

discharge of the volatile species under vacuum at 120° C.,

cooling,

addition of constituents 5 to 7,

homogenization for 45 min.

A preparation referred to as RTVA is thus obtained. The additive is added as indicated in Example 2.

2) Catalysed mixture:

Part B:

[lacuna] parts of phenyltrimethoxysilane

2 parts of dimethyltin didecanoate

68 parts of a trimethylsilyl-terminated PDMS with a viscosity of 100 mPa·s.

The catalysed mixture is prepared in a simple mixer of the type with a central shaft; it is used in a proportion of 10 parts per 100 parts of RTVA.

It should be noted that the POSs in accordance with the invention also have a protective action against UV radiation and can be used for this purpose.

It should be clearly understood that the invention defined by the appended claims is not limited to the specific embodiments indicated in the above description but encompasses the alternative forms thereof which do not depart either from the scope or from the spirit of the present invention.

1. Use, as antioxidant for polymer compositions, of a polyorganosiloxane POS polymer having essentially a structure chosen from that of formula (1): 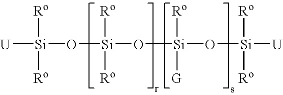
in which:
the R^{o} radicals, which are identical or different, are chosen from: the hydrogen atom, a hydrolysable group, a hydroxyl group and a monovalent hydrocarbonaceous group having in particular from 1 to 20 carbon atoms;
the U units, which are identical or different, are chosen from R^{o}, G, a hydrogen, a hydrolysable group, a hydroxyl group and an alkenyl group;
G is a residue resulting from an antioxidant additive;
r is an integer chosen between 0 and 400;
s is an integer chosen between 0 and 100;
r+s is between 0 and 500, preferably between 10 and 100;
if s=0, at least one of the U radicals is G; and from that of formula (2): 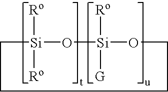
in which:
R^{o} and G have the same meanings as in the formula (1);
u is an integer between 1 and 20;
t is an integer between 0 and 20;
t+u≧3, preferably between 3 and 10.

2. Use according to claim 1, characterized in that the polymer is of formula (1) with r between 0 and 50 and s between 0 and 50.

3. Use according to either one of claims 1 and 2, characterized in that the G functional group or groups result from compounds chosen from sterically hindered mono- and polyphenols carrying an unsaturated, alcohol or ester functional group; aromatic amines carrying an unsaturated, phenol or NH functional group; HALS hindered amines carrying an unsaturated, alcohol or ester functional group; amine N-oxides carrying an unsaturated functional group; phosphines and phosphites, in particular alkyl phosphites, mixed aryl alkyl phosphites or aryl phosphites, carrying an ester or halogen functional group; and antioxidant additives which, once grafted to the POS, comprise, in their structure, at least one group of formula:

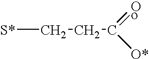

4. Use according to claim 3, characterized in that the G functional group or groups result from the following compounds:
2,6-di(t-butyl)phenol, 2,6-di(t-butyl)-4-methylphenol, octadecyl 3,5-di(t-butyl)-4-hydroxyhydrocinnamate, 4,4′-methylenebis(2,6-di(t-butyl)-phenol), 4,4′-methylenebis(2,6-dimethylphenol), 2,2′-methylenebis(4-methyl-6-(t-butyl)phenol), 2,2′-ethylidenebis(4,6-di(t-butyl)phenol), 2,2′-methylenebis(4-methyl-6-(1-methylcyclohexyl)-phenol), 4,4′-butylidenebis(6-t-butyl-3-methylphenol), 1,1′-thiobis(2-naphthol), 2,2′-thiobis(4-methyl-6-t-butylphenol), 2,2′-isobutylidenebis(4,6-dimethylphenol), monomethacrylate ester of 2,2′-methylenebis(4-ethyl-6-t-butylphenol), 1,3,5trimethyl-2,4,6-tris(3,5-di(t-butyl)-4-hydroxybenzyl)benzene, 4,4′-thiobis(6-t-butyl-3-methylphenol), 4,4′-thiobis(4,6-di(t-butyl)phenol), 2,6-di(t-butyl)-p-cresol, 2-t-butyl-4-methoxyphenol, 3-t-butyl-4-methoxyphenol, alkyl-, dialkyl- or trialkyl-substituted phenols with C₁ to C₃₀ alkyl, styrylphenol, distyrylphenol, tristyrylphenol, tetrakis(methylene 3-(3,5-di(t-butyl)-4-hydroxyphenyl)propionate)methane, 1,3,5-trimethyl-2,4,6-tris(3,5-di(t-butyl)-4-hydroxybenzyl)benzene, 1,3,5-tris(3,5-di(t-butyl)-4-hydroxybenzyl)-s-triazine-2,4,6(1H,3H,5H)-trione, 2,4-bis(n-octylthio)-6-(4-hydroxy-3,5-di(t-butyl)amino)-1,3,5-triazine, 4-(hydroxymethyl)-2,6-di(t-butyl)phenol or 2,2-diphenyl-1-picrylhydrazyl;
N-phenylbenzylamine, N-phenyl-1-naphthylamine, 4,4′-di(α,α′-dimethylbenzyl)diphenylamine, 4,4′-di(2,4,4-trimethylpentyl)diphenylamine, N,N′diphenyl-1,4-phenylenediamine, N-phenyl-N′-(1,3-dimethylbutyl)-1,4-phenylenediamine or 4-anilinophenyl methacrylate;
amines of N—OR type, in particular those comprising at least one group: 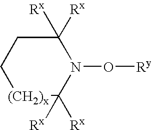
in which R^{y} is hydrogen or a linear or branched C₁ to C₁₈ alkyl, optionally substituted by one or more phenyl groups, or a C₅ to C₆ cycloalkyl or benzyl, a is 0 or 1, preferably 1, and the R^{x} radicals, which are identical to or different from one another, are chosen from linear or branched C₁ to C₃ alkyl, phenyl and benzyl radicals;
triphenyl phosphite, triisodecyl phosphite, trilauryl phosphite, dilauryl phosphite, diphenyl isodecyl phosphite, diphenyl isooctyl phosphite, diphenyl 2-ethylhexyl phosphite, diisodecyl phenyl phosphite, trimonononylphenyl phosphite, 2,4-dinonylphenyl di(4-monononylphenyl) phosphite, tris(2,4-di(tert-butyl)phenyl) phosphite (CAS 31570-04-4), 2,2-methylenebis(4,6-di(t-butyl)phenyl) octyl phosphite;
tridecyl thiodipropionate, distearyl 3,3′-thiodipropionate, di(tridecyl thiodipropionate) or dilauryl 3,3′-thiodipropionate.

5. Use according to claim 3, characterized in that the G functional group or groups result from the following compounds:

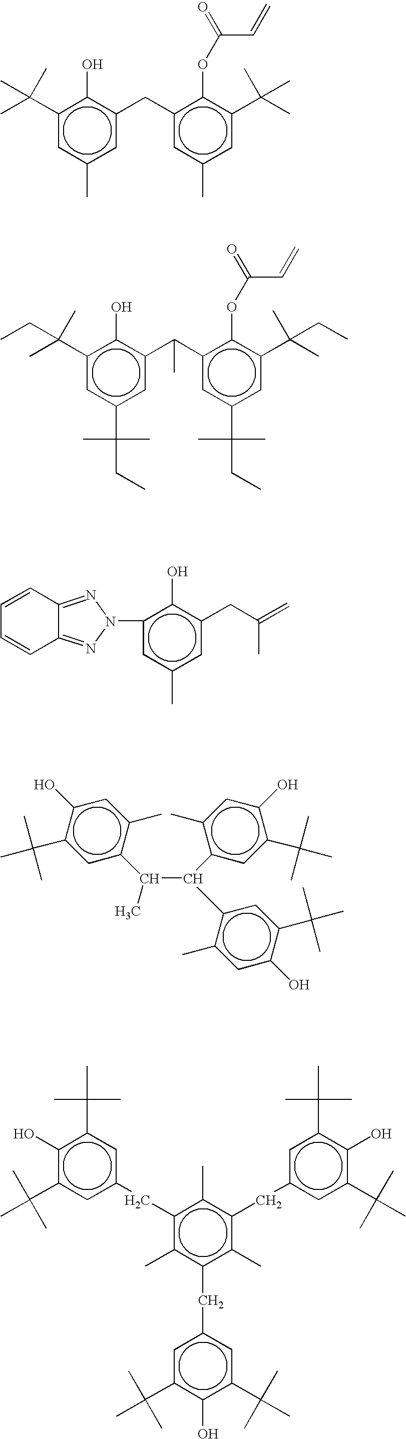

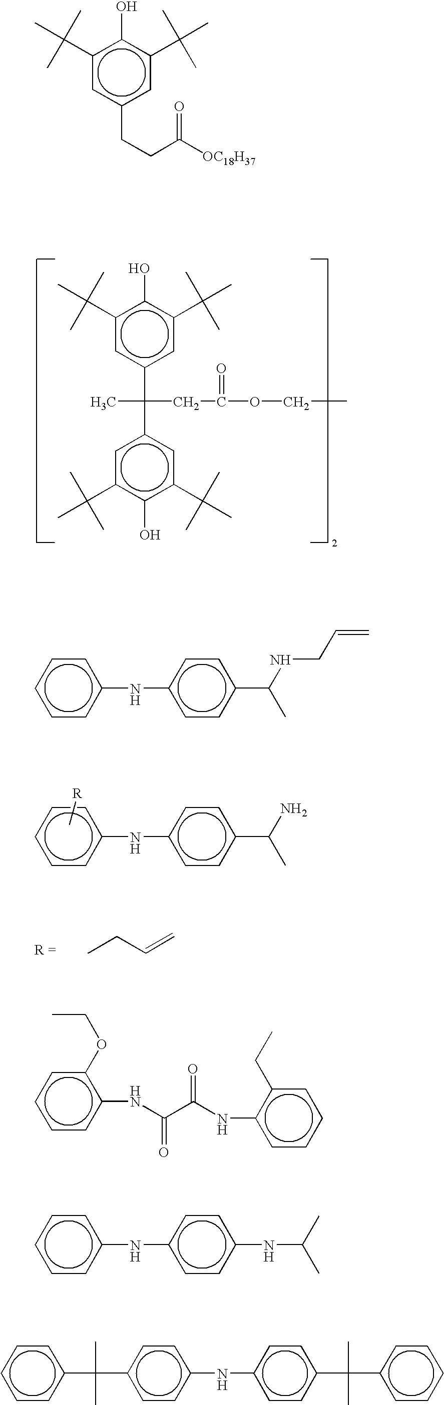

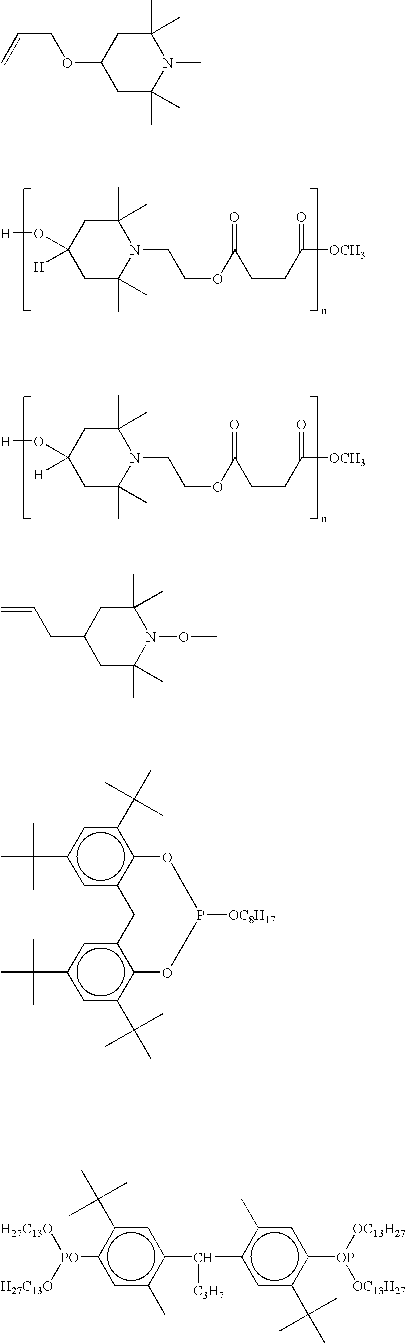

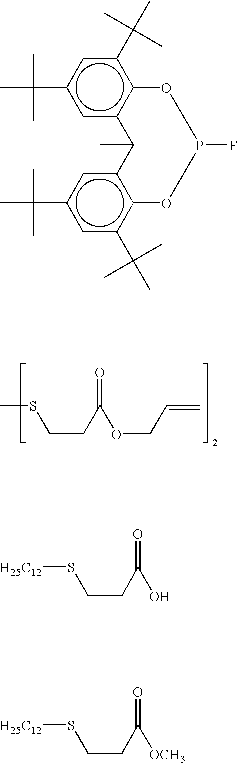

6. Use according to any one of claims 1 to 5, characterized in that, in the formula (1) or (2), the R^{o} radicals are chosen from methyl, ethyl, propyl, butyl, hexyl, octyl, vinyl, phenyl or 3,3,3-trifluoropropyl; preferably, at least 80% of the R^{o} radicals are methyl.

7. Use according to any one of claims 1 to 6 for the stabilization of silicone compositions with respect to oxidation.

8. Use according to claim 7 for the stabilization of silicone compositions intended to form elastomers used in the production of moulds.

9. Use according to claim 8 for the stabilization of the constituent silicone elastomers of moulds intended for the moulding of polyester items in order to prevent, within the silicone elastomer, the polymerization of the styrene resulting from the polyester resin, without interfering with the polymerization at the core and at the surface of the polyester.

10. Use according to any one of claims 7 to 9, characterized in that the polymer of formula (1) or (2) is a constituent of the elastomeric network.

11. Use according to any one of claims 1 to 6 for the stabilization of organic polymer compositions with respect to oxidation.

12. Use according to claim 11 for the stabilization of compositions comprising an organic polymer chosen from the group consisting of: polyolefins, polyalkadienes, polystyrenes, polyurethanes, polyamides, polyesters, polycarbonates, polysulphones, polyethersulphones, polyetherketones, acrylic polymers, their copolymers and their blends.

13. Use according to claim 12 for the stabilization of compositions comprising an organic polymer chosen from the group consisting of: polypropylene, high density polyethylene, linear low density polyethylene, low density polyethylene, polybutadiene, their copolymers and their blends.

14. Use according to any one of claims 1 to 13, characterized in that, for the stabilization of silicone compositions or the stabilization of organic polymer compositions, the POSs of formula (1) or (2) as defined in any one of claims 1 to 6 are combined with ungrafted antioxidant additives, in particular those described as compounds capable of being grafted.

15. Use according to claim 14, characterized in that use is made in addition of an ungrafted additive chosen from bis(1-octyloxy-2,2,6,6-tetramethyl-4-piperidyl) sebacate, thiodipropionates and monothiopropionates.

16. Precursor silicone composition for a silicone elastomer comprising a POS polymer as defined in any one of claims 1 to 6,

17. Composition according to claim 16, characterized in that it comprises:
(A) a diorganopolysiloxane oil exhibiting reactive groups chosen from i) condensable, hydrolysable or hydroxyl terminal groups and 2i) alkenyl groups, preferably vinyl groups, bonded to silicon;
(B) optionally a compound chosen from the group consisting of silanes comprising condensable or hydrolysable groups, in the case where (A) is chosen from the groups i), and of diorganopolysiloxane oil carrying hydrogen atoms, in the case where (A) is chosen from the groups 2i);
(C) a catalyst.

18. Composition according to claim 17, characterized in that the oil A and/or the compound B carry G functional groups as defined in any one of claims 1 to 6.

19. Silicone elastomer obtained by crosslinking a composition according to any one of claims 16 to 18.

20. Mould made of silicone elastomer according to claim 19.

21. Organic polymer composition comprising a POS polymer as defined in any one of claims 1 to 6, with the exception of POS carrying HALS groups.

22. Composition according to claim 21 comprising an organic polymer chosen from the group consisting of:
polyolefins, polyalkadienes, polystyrenes, polyurethanes, polyamides, polyesters, polycarbonates, polysulphones, polyethersulphones, polyetherketones, acrylic polymers, their copolymers and their blends.

23. Composition according to claim 22 comprising an organic polymer chosen from the group consisting of:
polypropylene, high density polyethylene, linear low density polyethylene, low density polyethylene, polybutadiene, their copolymers and their blends.

24. Grafted polyorganosiloxanes POS as defined in any one of the claims 1 to 6 with the proviso that they do not contain piperidinyl and benzotriazol groups.
